(19) United States
(12) Patent Application Publication
(10) Pub. No.: US 2026/0113211 A1
(43) Pub. Date: Apr. 23, 2026

(54) SYMMETRIC MULTICAST COMMUNICATION FOR OFFLOAD OPERATIONS

(71) Applicant: NVIDIA Corporation, Santa Clara, CA (US)

(72) Inventors: Arnav GOEL, Santa Clara, CA (US); Akhil LANGER, Santa Clara, CA (US); Seth Daniel HOWELL, Gilbert, AZ (US)

(21) Appl. No.: 18/918,959

(22) Filed: Oct. 17, 2024

(51) Int. Cl. H04L 12/18; H04L 12/46

(52) U.S. Cl. CPC H04L 12/1886; H04L 12/4641

(57) ABSTRACT

Systems, methods, apparatuses, and computer program products for zero-copy symmetric multicast communication buffers for offload operations. A method may include receiving an instruction for performing a collective operation across a plurality of processing elements. The method may also include determining an offset of the first virtual address from a first base address associated with the first set of contiguous virtual addresses. The method may further include translating the first virtual address to a corresponding multicast virtual address based on the offset. Further, the method may include causing the collective operation to be performed based at least on the multicast virtual address.

### TECHNICAL FIELD

Various embodiments relate generally to computing system architectures and, more specifically, to zero-copy symmetric multicast communication buffers for offload operations.

### BACKGROUND

With the rapid development in artificial intelligence (AI) and high performance computing (HPC), high -speed interconnection and scalability of graphics processing units (GPUs) have resulted in needs of higher-bandwidth availability while maintaining low-latency and high-performance. For instance, in one aspect, there has been a growing need to accelerate collective communication operations for inter-GPU communication by enabling certain offload technologies in deep-learning and HPC applications. The use of such technologies may be exposed through Compute Unified Device Architecture (CUDA®) multicast software interfaces, which provides support for creating, subscribing, and dynamic binding/unbinding GPU communication buffers (e.g., unicast buffers) to multicast mappings (e.g., multicast buffers).

Existing inter-GPU communication libraries may support unicast and multicast communication buffers by performing multiple copies of the buffers to enable address translation. This may negatively impact end-to-end inter-GPU communication performance by increasing latency and decreasing bandwidth. Additionally, these libraries support multi-step lookup to translate unicast to multicast addresses in the critical path of collective communication calls, which in turn negatively impacts the setup/teardown time performance of dispatching communication operations.

As the foregoing illustrates, there is a need to accelerate collective communication operations for inter-GPU communication.

### SUMMARY

Example embodiments of the present disclosure relate to zero-copy symmetric multicast communication buffers for offload operations. The techniques described herein may include a method, comprising: receiving an instruction for performing a collective operation across a plurality of processing elements, wherein the instruction specifies a first virtual address that is included in a first set of contiguous virtual addresses for unicast operations; determining an offset of the first virtual address from a first base address associated with the first set of contiguous virtual addresses; translating the first virtual address to a corresponding multicast virtual address based on the offset, wherein the multicast virtual address is included in a second set of contiguous virtual addresses for multicast operations, and wherein the multicast virtual address is located at the offset from a second base address associated with the second set of contiguous virtual addresses; and causing the collective operation to be performed based at least on the multicast virtual address.

Other example embodiments may include, without limitation, an apparatus, comprising: at least one processor; and at least one memory storing instructions, wherein the instructions, when executed by the at least one processor, cause the apparatus at least to: receive an instruction for performing a collective operation across a plurality of processing elements, wherein the instruction specifies a first virtual address that is included in a first set of contiguous virtual addresses for unicast operations; determine an offset of the first virtual address from a first base address associated with the first set of contiguous virtual addresses; translate the first virtual address to a corresponding multicast virtual address based on the offset, wherein the multicast virtual address is included in a second set of contiguous virtual addresses for multicast operations, and wherein the multicast virtual address is located at the offset from a second base address associated with the second set of contiguous virtual addresses; and cause the collective operation to be performed based at least on the multicast virtual address.

### BRIEF DESCRIPTION OF THE DRAWINGS

So that the manner in which the herein recited features of the various embodiments may be understood in detail, a more particular description of the inventive concepts, briefly summarized herein, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

The present systems and methods for zero-copy symmetric multicast communication buffers for offload operations are described in detail below with reference to the attached drawing figures, wherein:

FIG. 1 illustrates an example system, according to certain example embodiments.

FIG. 2 illustrates an example of another system, according to certain example embodiments.

FIG. 3 illustrates an example heap configuration, according to certain example embodiments.

FIG. 4A illustrates an example symmetric unicast heap and a symmetric multicast heap, according to certain example embodiments.

FIG. 4B illustrates a unicast to multicast translation process in a processing element (PE) prior to execution of a collective operation, according to certain example embodiments.

FIG. 4C illustrates an example flow diagram of a method of unicast to multicast translation in a processing engine, according to certain example embodiments.

FIG. 5 illustrates an example block diagram of a computing device, according to certain example embodiments.

FIG. 6 illustrates is an example block diagram of a parallel processing unit (PPU) included in the graphics processing units (GPUs) of FIG. 5, according to certain example embodiments.

FIG. 7 illustrates an example block diagram of a general processing cluster (GPC), according to certain example embodiments.

FIG. 8 illustrates an example data center 800, according to certain example embodiments.

FIG. 9 illustrates an example Compute Unified Device Architecture (CUDA®) implementation, according to certain example.

### DETAILED DESCRIPTION

Systems and methods disclosed herein relate to zero-copy symmetric multicast communication buffers for offload operations. As described herein, certain example embodiments provide the ability to accelerate collective communication operations by creating on-demand zero-copy multicast communication buffers at a same virtual offset as corresponding unicast communication buffers. Certain example embodiments may also provide unicast to multicast address translation, where the unicast and multicast communication buffers are allocated in a contiguous virtual address space of a symmetric heap associated with each participating graphics processing unit (GPU). By providing such capability, it may be possible to achieve a simple address arithmetic base translation scheme to be deployed.

In the following description, numerous specific details are set forth to provide a more thorough understanding of the various example embodiments. However, it will be apparent to one skilled in the art that the inventive concepts may be practiced without one or more of these specific details.

The features, structures, or characteristics of example embodiments described throughout this specification may be combined in any suitable manner in one or more example embodiments. For example, the usage of the phrases “certain embodiments,” “an example embodiment,” “some embodiments,” or other similar language, throughout this specification refers to the fact that a particular feature, structure, or characteristic described in connection with an embodiment may be included in at least one embodiment. Thus, appearances of the phrases “in certain embodiments,” “an example embodiment,” “in some embodiments,” “in other embodiments,” or other similar language, throughout this specification do not necessarily refer to the same group of embodiments, and the described features, structures, or characteristics may be combined in any suitable manner in one or more example embodiments.

As used herein, “at least one of the following: <a list of two or more elements>” and “at least one of <a list of two or more elements>” and similar wording, where the list of two or more elements are joined by “and” or “or,” mean at least any one of the elements, or at least any two or more of the elements, or at least all the elements.

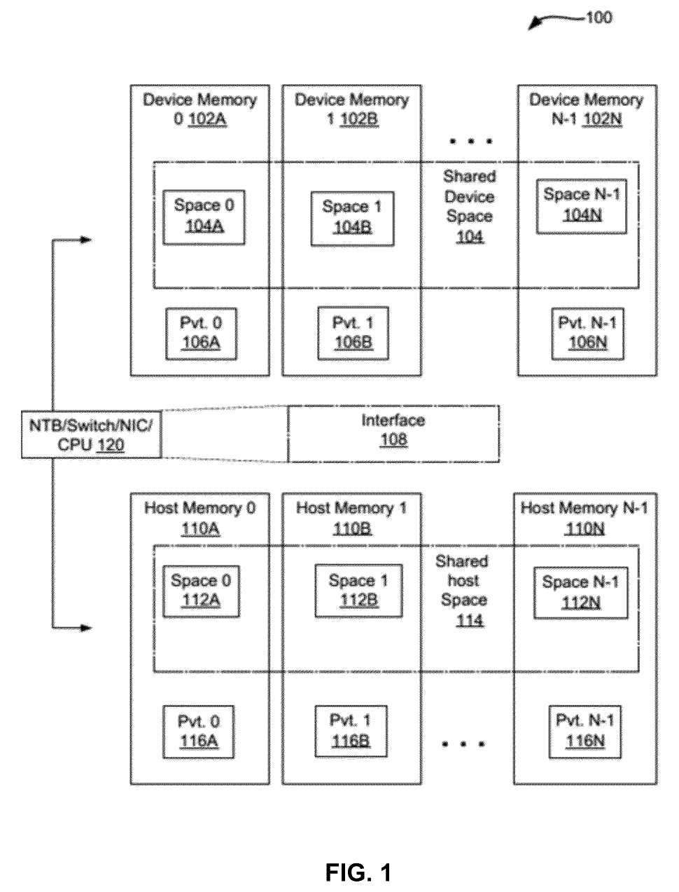

FIG. 1 illustrates an example system, according to certain example embodiments. The system 100 includes an interface, such as a programming interface 108, to allow applications and their different processes (e.g., processes associated with GPUs or other processing units) to provide specifications associated with different memory size requests for the different processes. A maximum of the different memory sizes may be used to provide equal allocations in a virtual memory for each process. Furthermore, the interface 108 may enable a mapping of a virtual memory space to a physical memory that includes the different memory sizes. This approach may be performed for each of different collective calls (e.g., collective operations) for each process. In certain example embodiments, the collective calls/operations may include but not limited to allgather, reduce, reduce-scatter, allreduce, and broadcast. The allreduce operation may include performing reductions on data (e.g., sum, min, max) across devices, and storing the result in a receiver buffer of every rank. The broadcast operation may include copying an N-element buffer from a root rank to all the ranks. The reduce-scatter operation may include performing a same operation as a reduce operation, except that the result is scattered in equal-sized blocks between ranks, and each rank obtains a chunk of data based on its rank index. The reduce operation may include the same operation as allreduce, except the result is stored only in the receive buffer of a specified root rank. The allgather operation may include gathering N values from k ranks into an output of size k*N, and distributing the result to all ranks. In some example embodiments, the equal allocation of virtual memory may use contiguous parts of the virtual memory for different requests in different collective calls that relate to the same process.

The virtual memory allocation approach may prevent memory wastage where physical memory is otherwise allocated in different sizes, as needed. The approach may also enable several new applications to use a programming model with different memory needs and may be provided while maintaining performance overheads consistent as if the memory requests are of the same size on every process. In certain example embodiments, the interface 108 may be associated with or may include a virtual memory management (VMM) application programming interface (API) or another API in a Compute Unified Device Architecture (CUDA®) and/or other parallel computing platform and programming model.

In certain example embodiments, the interface 108 may allow separation of physical memory by an accumulation step followed by an allocation step. The allocation step allows allocation from a virtual address space by reservation. In various embodiments, when a memory allocation routine or function is called, a maximum size associated with accumulated memory requests across different processes (e.g., processes associated with GPUs or other processing units) may be determined for a first collective call/operation. For each process making a request in the first collective call, for instance, the interface 108 reserves a virtual address space corresponding to the maximum size of all the accumulated memory requests. However, an associated physical memory that is mapped to the virtual memory may remain allocated to the local processes, at the requested memory size of each of the processes. Therefore, the physical memory of different allocated sizes may be mapped to the virtual address space that remains symmetric across all processing elements/processing engines (PEs). Further, on a second or further collective call for a same process, the virtual memory allocation is in contiguous blocks, whereas the physical memory allocation occurs as required. These approaches enable unequal sized requests for different processes while keeping address translation overheads the same as expected for equal sized requests, which may be critical for performance of communication routines for the different processes.

In certain example embodiments, the interface 108 (e.g., an API) may be associated with different applications or their processes to allow applications to provide specifications of different memory sizes for different processes (e.g., processes associated with GPUs or other processing units). The interface 108 can enable equal allocated sizes of the virtual memory to the applications based on a maximum of the different memory sizes, and can enable the mapping between the virtual memory and the physical memory as a step of the memory requests by the different processes. A translation for the mapping may then occur using a start address and the maximum of the different memory sizes.

In certain example embodiments, the API can reserve virtual addresses in a virtual memory, which may require symmetry, in that, each process may be allocated an equal amount of virtual memory. Although the processes can have different memory requirements, a maximum of these requirements may be used to perform the allocation of the virtual memory space. Allocation of physical memory may be performed by a request from each process, at the time of the request or execution of the process, to map different sizes of the physical memory against the equally sized parts of the virtual memory. The API herein can determine a largest or maximum memory needed, and can obtain that amount of address space in the virtual memory for all the processes ongoing at that time. The API can then map a necessary amount of physical memory for each process and, thus, the physical memory may be of different sizes. Some unused virtual memory may be acceptable in this approach, but each process element may have contiguous virtual memory blocks or address ranges, for each collective call performed, so that translation overheads appear as if the process requests are for equal memory allocation.

In certain example embodiments, the physical memory may be from multiple processors that may be all treated as a single memory. In some example embodiments, such as in NVLINK® communications, address translation may be used to translate virtual addresses of the virtual memory to physical addresses of the physical memory at a destination process of the different processes. In Remote Direct Memory Access (RDMA), memory registration or on-demand paging may be used to enable a part of the virtual memory to be in a mapping with respect to a part of a physical memory. Further, memory region (MR) keys can be provided to confirm the mapping; or a registration associated with the mapping may be used. These approaches may limit increases in translation overheads as virtual memory allocations can be addressed by a start address and by a size of the equal allocations alone.

According to certain example embodiments, the interface 108 may herein allow a virtual memory to be equally sized, partitioned, or distributed, and further, to be contiguous for different collective calls for a same process, based in part on request by an application to perform a process. The mapping of the partitioned virtual memory to a physical memory may be performed at the request of the process itself, and translation or registration may use the start address and maximum memory sizes. As a result, the physical memory may remain of different or required sizes for the process, but the virtual memory may be equally distributed based on the application requirements. In some example embodiments, the virtual memory address space may include unicast and/or multicast addresses, and the unicast memory addresses may be mapped to multicast memory addresses through software interfaces such as, for example, the interface 108.

As illustrated in FIG. 1, the system 100 that is subject to example embodiments of non-uniform allocation of symmetric memory in parallel programs may include host memory 0 – N-1 110A-N, such as, memory associated with one or more central processing units (CPUs), or device memory 0 - N-1 102A-N, such as, memory associated with one or more GPUs. In certain example embodiments, the device memory 0 – N-102A-N may be an on-chip memory of a GPU, or a dynamic random access memory (DRAM) that is associated with a GPU and that may be accessed over a memory bus. In some example embodiments, the memory bus may be PCI Express (PCIe)-supportive and a GPU may be a PCIe device.

In certain example embodiments, the device memory may be an address space that may require data to be transferred therein through specific mechanisms prior to computation or processing performed by the GPU. CUDA® may provide a framework that can take advantage of GPUs to support “GPUDirect” access, which is data movement among GPUs, such as, between GPUs and other related PCIe devices. A further GPUDirect RDMA (GDR) feature supports InfiniBand® network adapters and supports direct read or write between a GPU’s device memory with the host memory being bypassed. Such approaches may provide performance benefits, and such heterogeneous systems may allow data transfer between Host-to-Host, Device-to-Device, Host-to-Device, and Device-to-Host memories.

As illustrated in FIG. 1, partitioned global addressing space (PGAS) herein may apply to a global address space (also referred to herein as a shared device and host space) 104, 114 that is a shared space 0 - N-1 104A-104N and 112A-112N of a combination of a host memory 0 - N-1 110A-N and a device memory 0 - N-1 102A-N. Further, each of the host memory and the device memory may include their respective private spaces 0 - N-1 106A-106N and 116A-116N. In at least one embodiment, the shared device and host space 104, 114 represents an extension of heterogeneous memory domains of a host and a device and may be indicated by “heap_on_device / heap_on_host” for the respective symmetry heaps. The host memory allocation may be referenced by a call for a host_buf and using a shmalloc function that includes a singular size, such as (sizeof(int), 0) for the host device; and the device memory allocation may be referenced by a call for a dev_buf and using a shmalloc function that includes a singular size, such as (sizeof(int), 1). However, it may be possible to use a function, such as shmem_putmem, to allow for data to be copied between contiguous or a global address space given by (dev_buf, dev_buf) to a data object on a PE, such as a process of a GPU or a CPU to which one or more of the illustrated memory belongs. In certain example embodiments, the function may include specification of a singular size associated with the PE.

Therefore, a global address space for a parallel programming model may require applications and their associated processes to call functions for memory allocation with a singular size aspect. Processes may call such functions with a same value of size to allow for fast address translation (e.g., translation from local address to remote address). Although such fast address translation may be possible, processes providing specifications of a same size may lead to wastage of physical memory on some processes. To address this issue and to keep translation overheads the same, an interface 108, such as an API, may be used to allow applications associated with different processes to provide specifications of different sizes and a VMM allows for accumulation of such different sizes prior to allocation to an equally sized physical memory, such as the host_buf and/or the dev_buf. In certain example embodiments, the API may allow the application to provide specifications of different sizes, and leverage CUDA’s VMM API for implementation.

As illustrated in FIG. 1, a non-transparent bridge (NTB), PCIe switch, network interface card (NIC), or host-side CPU 120 may be provided between different devices providing the shared device and host spaces 104, 114. The NTB, PCIe switch, NIC, or host-side CPU 120 may support, enable, or include one or more aspects of the interface 108. As further illustrated in FIG. 1, there may be multiple host machines networked together in a high-speed network, which can support their respective GPUs between networked together in a bypass high-speed network. Further, the device memories of such GPUs and the host memories of such host machines may be enabled to provide the shared device and host spaces 104, 114.

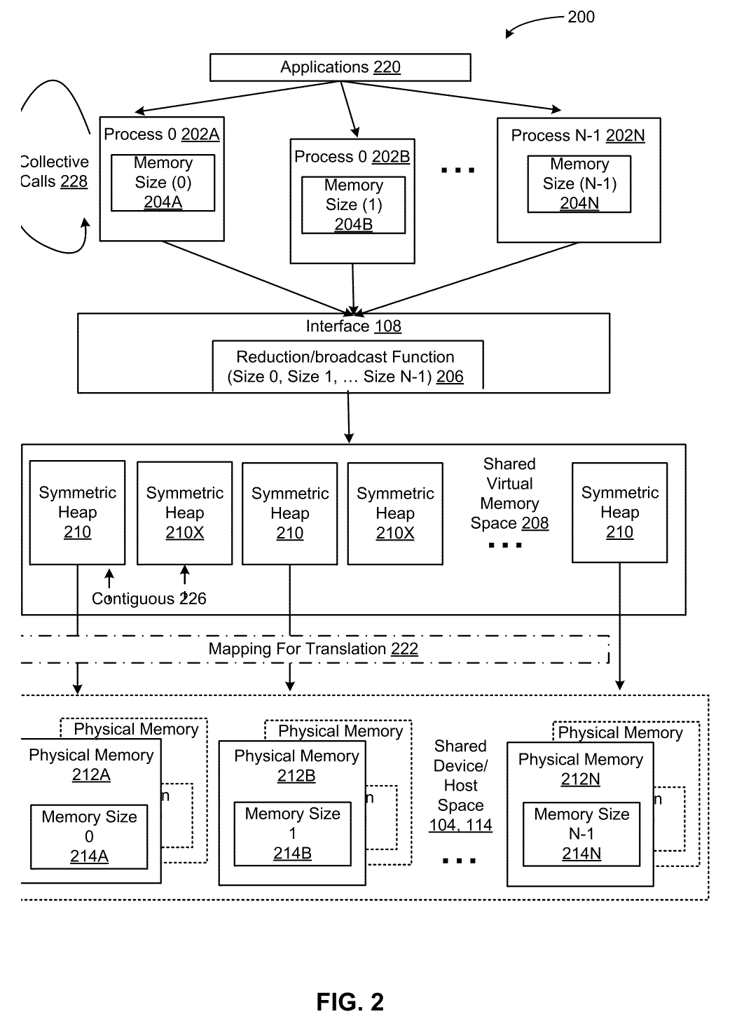

FIG. 2 illustrates an example system 200, according to certain example embodiments. In some example embodiments, the system 200 may be associated with non-uniform allocation of symmetric memory in parallel programs, according to at least one embodiment. The system 200 includes an interface 108 with at least a reduction/broadcast function 206 therein. The interface 108 may be one or more APIs, such as a reduction API and a CUDA® VMM API. The interface 108 can create an address space layout for a symmetric memory that enables asymmetric allocation sizes without introducing new overheads. The symmetric memory may be used as physical memory for processes of parallel programs or applications, and the physical memory may be available for communication across the processes. For example, the CUDA® VMM API may be used to reserve a virtual address range and provide a mapping for Inter-Process Communication (IPC) associated with the CUDA® framework. In various embodiments, IPC may be executed via CUDA POSIX File Descriptor (e.g., CU_MEM_HANDLE_TYPE_POSIX_FILE_DESCRIPTOR or CUDA Fabric Handle Type (e.g., CU_MEM_HANDLE_TYPE_FABRIC). At the point of reserving, which may be performed by an accumulation function, there may be no physical memory assigned to any application or associated process. Further, allocation of a symmetric virtual address space (or range) may cover a maximum size of different asymmetric allocation requests.

In certain example embodiments, the processes 0 - N-1 202A-202N may be operating processes tied to or otherwise associated with one or more applications 220. Such processes may be executed on one or more nodes in a cluster that may include GPUs and/or a host processor. According to certain example embodiments, the applications 220 may cause a job to be launched by a process manager. Then, each process associated with the job may execute a copy of an executable program. In certain example embodiments, the job may represent a single program multiple data (SPMD) feature that supports parallel execution. In other example embodiments, a PE may be assigned an integer identifier (ID) with a value that ranges from 0 - N-1 202A-202N. The IDs may be used to identify a source or a destination process and may also be used by application developers to assign work to specific PEs for a job.

According to certain example embodiments, all the PEs associated with a job may, simultaneously (or collectively), call an initialization routine. According to some example embodiments, this may be performed before an operation can be performed by any of the PEs. As such, before exiting, the PEs may also collectively call a finalization function. During post-initialization, an ID and a total number of running PEs may be queried by a process manager. The PEs may communicate and share data through symmetric memory that is allocated from a symmetric heap located in GPU memory and/or a shared device and host space 104, 114, if an extension is performed. This memory may be allocated by using the interface 108 that may be a CPU-side API. As discussed with respect to FIG. 1, the portion of the memory allocated using any other method may be considered private memory 106A-N and 116A-N that may be for allocating to a PE and that may not be accessible by other PEs.

As illustrated in FIG. 2, the interface 108 may receive allocation requests that include specifications of memory sizes 0 - N-1 204A-204N, from the different processes and, by extension, the associated applications 220. Therefore, in certain example embodiments, the interface 108 may enable the applications 220 to provide specifications of different memory sizes 0 - N-1 204A-204N that may be associated with different processes 202A-202N. The interface 108 may also enable equal allocation of shared virtual memory 208. The shared virtual memory space 208 may include a series of contiguous symmetric heap 210 made up of sets of contiguous memory addresses for each PE. At least one part of the shared virtual memory space 208 may be associated with a mapping 222 (to be used with translations, for instance) to one part of a physical memory 212A-N that may be part of a shared device and host space 104, 114. The mapping 222 may include different memory sizes 0 – N-1 214A-214N of the respective physical memory 212A-N, and may be associated with at least one process of the different processes based on a request by the at least one process. For example, the mapping 222 may be performed during or prior to execution of the process, as part of the allocation of the shared virtual memory space 208. In certain example embodiments, when the mapping 222 is performed prior to execution of the process, the collective call 228 may be performed directly on the PE, while the mapping 222 is setup upfront between initialization of the collective call and execution of the collective call. Alternatively, when the mapping 222 is performed during execution of the process, the mapping may be performed only on the CPU 120. The mapping may be between the physical memory 212A-212N and the virtual addresses within each symmetric heap 210-210X of the shared virtual memory space 208. Additionally, each symmetric heap 210-210X may be allocated for various PEs, and the virtual addresses may be mapped to corresponding physical addresses of the physical memory 212A-212N. Further, the translation for the mapping may occur using a start address, such as of the virtual address space allocated, and the maximum of the different memory sizes 0 - N-1 204A-204N.

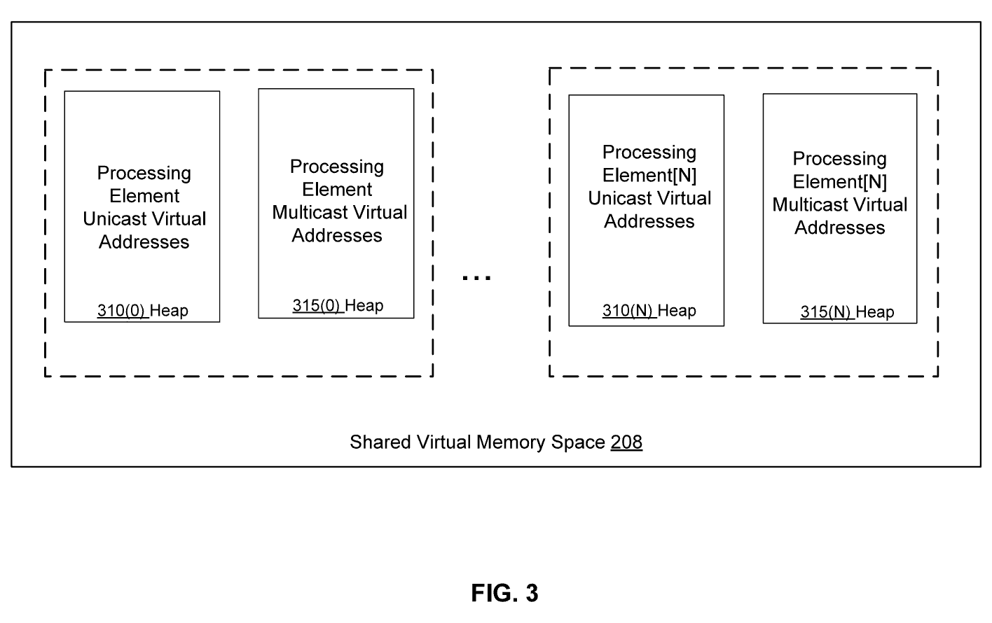

In certain example embodiments, the system 200 may provide unicast to multicast address translation where unicast and multicast communication buffers are allocated in a contiguous virtual address space of symmetric heaps 210-210X. For instance, in certain example embodiments, the shared virtual memory space 208 may include symmetric heap 210 for each process 202A-202N or PE. The symmetric heap 210 may correspond to symmetric heap for unicast and symmetric heap for multicast either in the context of a collective call 228 or when there is no collective call. According to certain example embodiments, to execute collective calls 228, a unicast virtual address may be translated to a corresponding multicast virtual address, as further described with respect to FIG. 3.

In certain example embodiments, in an NVLink® implementation, an underlying address translation mechanism may use the mapping 222 to translate from a shared virtual memory space 208 (also referred to as a symmetric virtual address space) to physical addresses of one of the physical memory 212A-212N of a destination process. According to certain example embodiments, the mapping may, therefore, be enabled to be a local operation, which preserves a symmetric virtual address space layout and eliminates critical path overheads.

According to certain example embodiments, physical blocks or address ranges representing parts 212A-212N of a physical memory or shared device/host space 104, 114 may remain at that requested malloc (allocation function) call values, such as 0.5MB for process 0202A and 1MB for process 11MB. Further, a mapping may be provided between the shared virtual memory space 208 and the shared device/host space 104, 114 to map the 1MB blocks to the different parts 212A-212N of the physical memory, representing the different sizes of the malloc calls or requests.

FIG. 3 illustrates an example construct of the shared virtual memory space 208 of FIG. 2. As illustrated in FIG. 3, symmetric heaps 210, 210X occupying the shared virtual memory space 208 may be one of a unicast virtual address heap 310(0)-310(N) or a multicast virtual address heap 315(0)-315(N). Each heap 310, 315 includes a set of contiguous virtual addresses. For a given pair of unicast virtual address heap 310 and a multicast virtual address heap 315, the set of contiguous virtual addresses across the pair correspond to one another, such that a virtual address in the unicast virtual address heap 310 is at a same offset from a base address of the unicast virtual address heap 310 as an offset of the corresponding virtual address in the multicast virtual address heap 315 from a base address of the multicast virtual address heap 315. Furthermore, each pair of unicast virtual address heap 310 and multicast virtual address heap 315 is associated with a different PE.

In certain example embodiments, unicast and multicast address spaces may be allocated for the collective calls 228 (e.g., collective operations). For instance, during a reduction operation in one example embodiment, unicast and multicast virtual address spaces may be allocated for unicast and multicast operations, respectively. When performing multicast operations, a mapping between the unicast virtual address that an associated PE is currently operating on is mapped to a corresponding multicast virtual address.

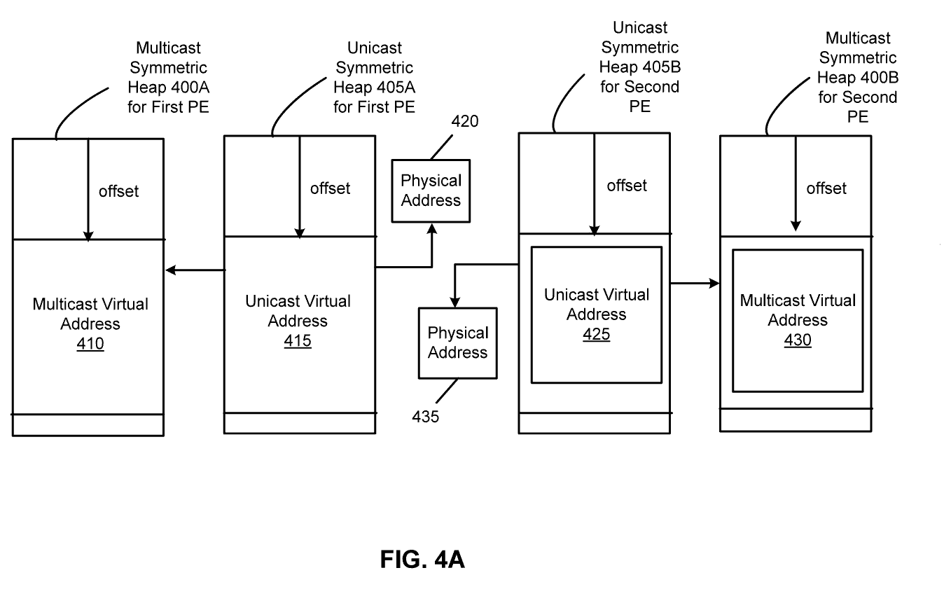

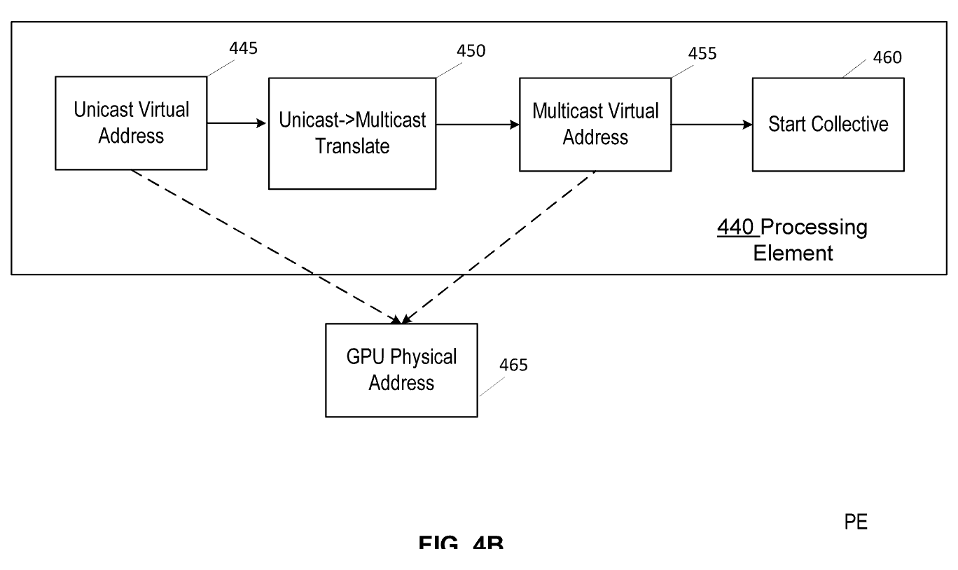

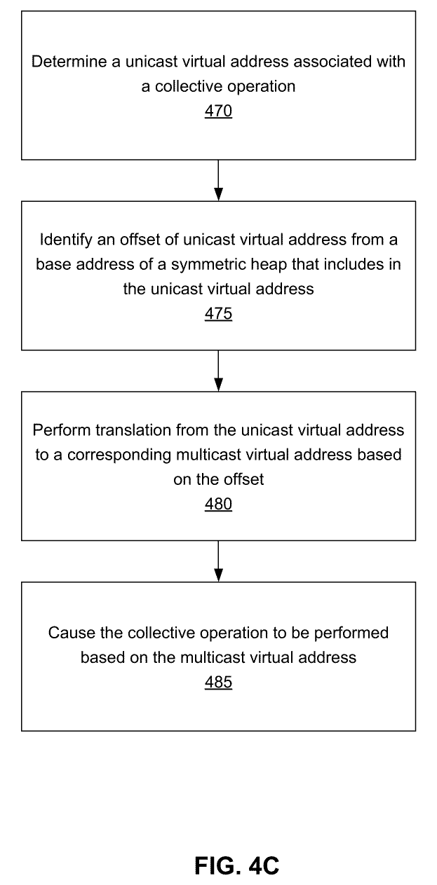

FIG. 4A illustrates example symmetric unicast heaps 405A and 405B and symmetric multicast heap 400A and 400B, according to certain example embodiments. The symmetric unicast heap 405A and the symmetric multicast heap 400A are a pair of symmetric heaps associated with a first PE. Similarly, the symmetric unicast heap 405B and the symmetric multicast heap 400B are a pair of symmetric heaps associated with a second PE.

As illustrated in FIG. 4A, the symmetric unicast heap 405A includes a unicast virtual address 415 at an offset from the base address of the symmetric unicast heap 405A. The symmetric multicast heap 400A includes a multicast virtual address 410 corresponding to the unicast virtual address 415 that is at the same offset from the base address of the symmetric multicast heap 400A. Each of unicast virtual address 415 and multicast virtual address 410 map to the same physical address 420 in the physical memory space associated with the first processing engine. Similarly, the symmetric unicast heap 405B includes a unicast virtual address 425 at an offset from the base address of the symmetric unicast heap 405B. The symmetric multicast heap 400B includes a multicast virtual address 430 corresponding to the unicast virtual address 425 that is at the same offset from the base address of the symmetric multicast heap 400B. Each of unicast virtual address 425 and multicast virtual address 430 map to the same physical address 435 in the physical memory space associated with the second processing engine.

In certain example embodiments, for a given collective call 228, when the translation from the unicast virtual address space to the multicast virtual address space occurs, an offset may be determined based on the unicast virtual address associated with the collective call 228. In certain example embodiments, the offset may be obtained by determining the difference between the unicast virtual address and the base address of the unicast symmetric heap 405A/405B. According to some example embodiments, the same offset is used to identify a corresponding multicast virtual address, where both the unicast and the multicast virtual address are mapped to the same physical memory address (e.g., GPU physical address).

FIG. 4B illustrates a unicast to multicast translation process in a PE 440 prior to execution of a collective operation, according to certain example embodiments. Unicast virtual address 445 is an address in the unicast symmetric heap 405. As discussed above, each PE is associated with a unicast symmetric heap 405A/405B and a multicast symmetric heap 400A/400B, where the offsets of a given virtual address in 405A/405B and 400A/400B are the same across all of the PEs. During a collective operation, in order to perform multicast operations across a plurality of PEs, a unicast virtual address 445 needs to be translated to a corresponding multicast virtual address 455 in the multicast symmetric heap 400. The translation 450 between the unicast virtual address 445 and multicast virtual address 455 is based on an offset of the unicast virtual address 445 from the base address of the unicast symmetric heap 405. In particular, the offset is computed as the difference between the unicast virtual address 445 and the base virtual address of the unicast symmetric heap 405. In other example embodiments, the translation 450 between the unicast virtual address 445 and multicast virtual address 455 may be based on a type of operation included in the collective operation/collective call. The multicast virtual address 455 is determined by adding the computed offset to the base address of the multicast symmetric heap 400. Both the unicast virtual address 445 and multicast virtual address 455 may be aliased to the same underlying physical memory address 465.

Moreover, in some example embodiments, the nature of the collective call/operation may determine which of a source buffer or destination buffer, or both buffers will be translated to a multicast virtual address space (e.g., multicast symmetric heap 400). In various embodiments, the translation 450 is advantageous as there is no buffer copy involved. In particular, as illustrated in FIG. 4A, the symmetric multicast heap 400A, 400B of FIG. 4A may be created by following the same offset model or the symmetric offset programming model of the symmetric unicast heap 405A, 405B. As such, it may be possible to extend the capabilities of unicast being zero copy, and achieve an order of one-to-one translation. It may also be possible to instantiate such translation in the CUDA® API.

Once the multicast virtual address of each PE participating in the collective operation is obtained, the collective operation can be started 460. The collective operation may be offloaded to a switch that couples the various PEs. For instance, in certain example embodiments, in the case of a reduction operation from within the GPU kernel, a virtual address to the GPU memory may be needed. In various example embodiments, the virtual address cannot be a unicast virtual address because the way the hardware identifies or distinguishes whether the hardware has to perform a unicast or a multicast operation is based on the virtual address being in a multicast virtual address space or a unicast virtual address space.

According to certain example embodiments, the PEs may be software controlled. For example, the PEs may receive instructions after which the PEs may inherently send messages to a switch to execute the operations including, for example, offload operations. Thus, according to certain example embodiments, the software may be dispatching or enqueueing work on the PEs. The PEs may then offload that work to the switch, and the switch may perform the operations and then obtain and transmit the results back to the PEs. As such, in certain example embodiments, the software end use operations or may issue operations on the PEs, and the PEs may then offload that to the switch while the PE performs other tasks. Additionally, the PE threads may be free to perform other operations while the switch is performing the operations.

FIG. 4C illustrates an example flow diagram of a method of unicast to multicast translation in a processing engine, according to certain example embodiments. At operation 470, a PE determines a unicast virtual address that is included in a first set of contiguous virtual addresses, wherein the unicast virtual address is associated with a collective operation performed across a plurality of processing elements. Once the unicast virtual address has been determined, at operation 475, the PE determines an offset of the unicast virtual address from a first base address associated with the first set of contiguous virtual addresses of a unicast symmetric heap that includes the unicast virtual address. As previously described, the offset may be computed by determining the difference between the virtual address and the base virtual address of the unicast symmetric heap. At operation 480, the PE performs a translation of the unicast virtual address to a corresponding multicast virtual address based on the offset. According to certain example embodiments, the multicast virtual address is included in a second set of contiguous virtual addresses for multicast operations, and the multicast virtual address is located at the offset from a second base address associated with the second set of contiguous virtual addresses. At operation 485, Once the multicast virtual address is obtained, the PE causes the collective operation to be performed based on the multicast virtual address. According to certain example embodiments, the unicast virtual address and multicast virtual address may be mapped to the same physical address associated with the PE.

According to certain example embodiments, each of the plurality of processing elements is associated with a corresponding first set of contiguous virtual addresses and a corresponding second set of contiguous virtual addresses. According to some example embodiments, the first set of contiguous virtual addresses corresponding to the plurality of processing elements are symmetric and the second set of contiguous virtual addresses corresponding to the plurality of processing elements are symmetric. According to other example embodiments, the method may also include, for a given processing element, binding a virtual address in the corresponding first set of contiguous virtual addresses to a first physical address in a physical memory space associated with the given processing element. According to certain example embodiments, a virtual address in the corresponding second set of contiguous virtual addresses that is located at a same offset as the virtual address in the corresponding first set of contiguous virtual addresses is bound the first physical address.

In certain example embodiments, the virtual address in the corresponding first set of contiguous virtual addresses is located at a current offset from the first base virtual address and the second virtual address in the corresponding second set of contiguous virtual addresses is located at the current offset from the second base virtual address. In some example embodiments, the collective operation is performed, at least in part, within a switch coupled to the plurality of processing elements. In other example embodiments, the method may also include determining that the first virtual address is to be translated to the multicast virtual address based on a type of operation included in the collective operation.

According to certain example embodiments, the instruction is received for a central processing unit coupled to the plurality of processing elements, and translating the first virtual address to a corresponding multicast virtual address occurs within the plurality of processing elements. According to some example embodiments, translating the first virtual address to a corresponding multicast virtual address is an O(1) operation. According to other example embodiments, the collective operation is performed across the plurality of processing elements based on data stored in the multicast virtual address corresponding to each of the plurality of processing elements. According to certain example embodiments, at least a partial result of the collective operation is stored in the multicast virtual address corresponding to each of the plurality of processing elements.

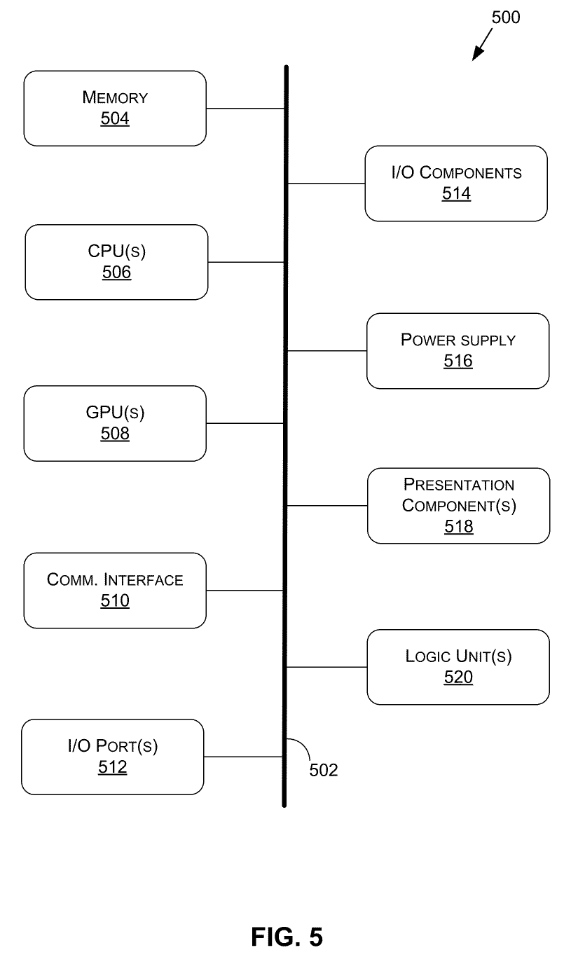

FIG. 5 illustrates an example block diagram of an example computing device, according to certain example embodiments. For instance, FIG. 5 illustrates a block diagram of an example computing device(s) 500 suitable for use in implementing various example embodiments described herein. Computing device 500 may include an interconnect system 502 that directly or indirectly couples the following devices: memory 504, one or more central processing units (CPUs) 506, one or more GPUs 508, a communication interface 510, input/output (I/O) ports 512, input/output components 514, a power supply 516, one or more presentation components 518 (e.g., display(s)), and one or more logic units 520. In at least one embodiment, the computing device(s) 500 may include one or more virtual machines (VMs), and/or any of the components thereof may include virtual components (e.g., virtual hardware components). For non-limiting examples, one or more of the GPUs 508 may include one or more vGPUs, one or more of the CPUs 506 may comprise one or more vCPUs, and/or one or more of the logic units 520 may comprise one or more virtual logic units. As such, a computing device(s) 500 may include discrete components (e.g., a full GPU dedicated to the computing device 500), virtual components (e.g., a portion of a GPU dedicated to the computing device 500), or a combination thereof.

Although the various blocks of FIG. 5 are shown as connected via the interconnect system 502 with lines, this is not intended to be limiting and is for clarity only. For example, in some example embodiments, a presentation component 518, such as a display device, may be considered an I/O component 514 (e.g., if the display is a touch screen). As another example, the CPUs 506 and/or GPUs 508 may include memory (e.g., the memory 504 representative of a storage device in addition to the memory of the GPUs 508, the CPUs 506, and/or other components). In other words, the computing device of FIG. 5 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 5.

The interconnect system 502 may represent one or more links or busses, such as an address bus, a data bus, a control bus, or a combination thereof. The interconnect system 502 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 506 may be directly connected to the memory 504. Further, the CPU 506 may be directly connected to the GPU 508. Where there is direct, or point-to-point connection between components, the interconnect system 502 may include a PCIe link to carry out the connection. In these examples, a PCI bus need not be included in the computing device 500.

The memory 504 may include any of a variety of computer-readable media. The computer-readable media may be any available media that may be accessed by the computing device 500. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 504 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 500. As used herein, computer storage media does not include signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 506 may be configured to execute at least some of the computer-readable instructions to control one or more components of the computing device 500 to perform one or more of the methods and/or processes described herein. The CPU(s) 506 may each include one or more cores (e.g., one, two, four, eight, twenty-eight, seventy-two, etc.) that are capable of handling a multitude of software threads simultaneously. The CPU(s) 506 may include any type of processor, and may include different types of processors depending on the type of computing device 500 implemented (e.g., processors with fewer cores for mobile devices and processors with more cores for servers). For example, depending on the type of computing device 500, the processor may be an Advanced RISC Machines (ARM) processor implemented using Reduced Instruction Set Computing (RISC) or an x86 processor implemented using Complex Instruction Set Computing (CISC). The computing device 500 may include one or more CPUs 506 in addition to one or more microprocessors or supplementary co-processors, such as math co-processors.

In addition to or alternatively from the CPU(s) 506, the GPU(s) 508 may be configured to execute at least some of the computer-readable instructions to control one or more components of the computing device 500 to perform one or more of the methods and/or processes described herein. One or more of the GPU(s) 508 may be an integrated GPU (e.g., with one or more of the CPU(s) 506 and/or one or more of the GPU(s) 508 may be a discrete GPU. In embodiments, one or more of the GPU(s) 508 may be a coprocessor of one or more of the CPU(s) 506. The GPU(s) 508 may be used by the computing device 500 to render graphics (e.g., 3D graphics) or perform general purpose computations. For example, the GPU(s) 508 may be used for General-Purpose computing on GPUs (GPGPU). The GPU(s) 508 may include hundreds or thousands of cores that are capable of handling hundreds or thousands of software threads simultaneously. The GPU(s) 508 may generate pixel data for output images in response to rendering commands (e.g., rendering commands from the CPU(s) 506 received via a host interface). The GPU(s) 508 may include graphics memory, such as display memory, for storing pixel data or any other suitable data, such as GPGPU data. The display memory may be included as part of the memory 504. The GPU(s) 508 may include two or more GPUs operating in parallel (e.g., via a link). The link may directly connect the GPUs (e.g., using NVLINK) or may connect the GPUs through a switch (e.g., using NVSwitch). When combined together, each GPU 508 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 506 and/or the GPU(s) 508, the logic unit(s) 520 may be configured to execute at least some of the computer-readable instructions to control one or more components of the computing device 500 to perform one or more of the methods and/or processes described herein. In certain example embodiments, the CPU(s) 506, the GPU(s) 508, and/or the logic unit(s) 520 may discretely or jointly perform any combination of the methods, processes and/or portions thereof. One or more of the logic units 520 may be part of and/or integrated in one or more of the CPU(s) 506 and/or the GPU(s) 508 and/or one or more of the logic units 520 may be discrete components or otherwise external to the CPU(s) 506 and/or the GPU(s) 508. In embodiments, one or more of the logic units 520 may be a coprocessor of one or more of the CPU(s) 506 and/or one or more of the GPU(s) 508.

Examples of the logic unit(s) 520 include one or more processing cores and/or components thereof, such as Data Processing Units (DPUs), Tensor Cores (TCs), Tensor Processing Units(TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 510 may include one or more receivers, transmitters, and/or transceivers that enable the computing device 500 to communicate with other computing devices via an electronic communication network, included wired and/or wireless communications. The communication interface 510 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 520 and/or communication interface 510 may include one or more data processing units (DPUs) to transmit data received over a network and/or through interconnect system 502 directly to (e.g., a memory of) one or more GPU(s) 508.

The I/O ports 512 may enable the computing device 500 to be logically coupled to other devices including the I/O components 514, the presentation component(s) 518, and/or other components, some of which may be built in to (e.g., integrated in) the computing device 500. Illustrative I/O components 514 include a microphone, mouse, keyboard, joystick, game pad, game controller, satellite dish, scanner, printer, wireless device, etc. The I/O components 514 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 500. According to certain example embodiments, the computing device 500 may be include depth cameras, such as stereoscopic camera systems, infrared camera systems, RGB camera systems, touchscreen technology, and combinations of these, for gesture detection and recognition. Additionally, the computing device 500 may include accelerometers or gyroscopes (e.g., as part of an inertia measurement unit (IMU)) that enable detection of motion. In some examples, the output of the accelerometers or gyroscopes may be used by the computing device 500 to render immersive augmented reality or virtual reality.

The power supply 516 may include a hard-wired power supply, a battery power supply, or a combination thereof. The power supply 516 may provide power to the computing device 500 to enable the components of the computing device 500 to operate.

The presentation component(s) 518 may include a display (e.g., a monitor, a touch screen, a television screen, a heads-up-display (HUD), other display types, or a combination thereof), speakers, and/or other presentation components. The presentation component(s) 518 may receive data from other components (e.g., the GPU(s) 508, the CPU(s) 506, DPUs, etc.), and output the data (e.g., as an image, video, sound, etc.).

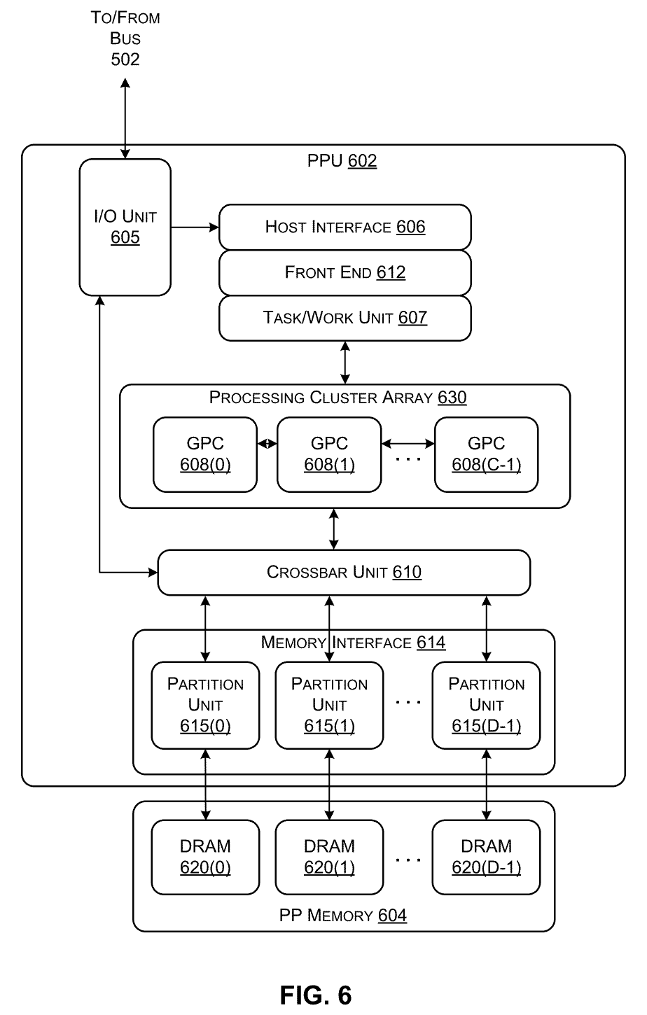

FIG. 6 illustrates is an example block diagram of a parallel processing unit (PPU) 602 included in the GPUs 608 of FIG. 5, according to certain example embodiments. Although FIG. 6 depicts one PPU 602, as indicated above, GPUs 508 can include any number of PPUs 602. As shown, PPU 602 can be coupled to a local parallel processing (PP) memory 604. PPU 602 and PP memory 604 may be implemented using one or more integrated circuit devices, such as programmable processors, application specific integrated circuits (ASICs), or memory devices, or in any other technically feasible fashion.

In some embodiments, PPU 602 may include a GPU that may be configured to implement a graphics rendering pipeline to perform various operations related to generating pixel data based on graphics data supplied by CPU 506 and/or memory 504. When processing graphics data, PP memory 604 can be used as graphics memory that stores one or more conventional frame buffers and, if needed, one or more other render targets as well. Among other things, PP memory 604 may be used to store and update pixel data and deliver final pixel data or display frames to presentation components 518 for display. In some embodiments, PPU 602 also may be configured for general-purpose processing and compute operations.

In operation, CPU 506 is the master processor of computing device 500, controlling and coordinating operations of other system components. In particular, CPU 506 issues commands that control the operation of PPU 602. In some example embodiments, CPU 506 writes a stream of commands for PPU 602 to a data structure (not explicitly shown in either FIG. 5 or FIG. 6) that may be located in memory 504, PP memory 604, or another storage location accessible to both CPU 506 and PPU 602. A pointer to the data structure is written to a pushbuffer to initiate processing of the stream of commands in the data structure. The PPU 602 reads command streams from the pushbuffer and then executes commands asynchronously relative to the operation of CPU 506. In certain example embodiments where multiple pushbuffers are generated, execution priorities may be specified for each pushbuffer by an application program via a device driver (not shown) to control scheduling of the different pushbuffers.

As also shown, PPU 602 includes an I/O (input/output) unit 605 that communicates with the rest of computing device 500 via interconnect system 502. I/O unit 605 generates packets (or other signals) for transmission on interconnect system 502 and also receives all incoming packets (or other signals) from interconnect system 502, directing the incoming packets to appropriate components of PPU 602. For example, commands related to processing tasks may be directed to a host interface 606, while commands related to memory operations (e.g., reading from or writing to PP memory 604) may be directed to a crossbar unit 610. Host interface 606 reads each pushbuffer and transmits the command stream stored in the pushbuffer to a front end 612.

The connection of PPU 602 to the rest of computing device 500 may be varied. In some embodiments, GPU 508, which includes at least one PPU 602, is implemented as an add-in card that can be inserted into an expansion slot of computing device 500. In other embodiments, PPU 602 can be integrated on a single chip with a bus bridge, such as interconnect system 502. Again, in still other embodiments, some or all of the elements of PPU 602 may be included along with CPU 506 in a single integrated circuit or system of chip (SoC).

In operation, front end 612 transmits processing tasks received from host interface 606 to a work distribution unit (not shown) within task/work unit 607. The work distribution unit receives pointers to processing tasks that are encoded as task metadata (TMD) and stored in memory. The pointers to TMDs are included in a command stream that is stored as a pushbuffer and received by the front end 612 from the host interface 606. Processing tasks that may be encoded as TMDs include indices associated with the data to be processed as well as state parameters and commands that define how the data is to be processed. For example, the state parameters and commands could define the program to be executed on the data. The task/work unit 607 receives tasks from the front end 612 and ensures that GPCs 608 are configured to a valid state before the processing task specified by each one of the TMDs is initiated. A priority may be specified for each TMD that is used to schedule the execution of the processing task. Processing tasks may also be received from the processing cluster array 630. Optionally, the TMD may include a parameter that controls whether the TMD is added to the head or the tail of a list of processing tasks (or to a list of pointers to the processing tasks), thereby providing another level of control over execution priority.

PPU 602 advantageously implements a highly parallel processing architecture based on a processing cluster array 630 that includes a set of C general processing clusters (GPCs) 608, where C ≥ 1. Each GPC 608 is capable of executing a large number (e.g., hundreds or thousands) of threads concurrently, where each thread is an instance of an independent sequence of instructions. In various applications, different GPCs 608 may be allocated for processing different types of programs or for performing different types of computations. The allocation of GPCs 608 may vary depending on the workload arising for each type of program or computation.

Memory interface 614 includes a set of D of partition units 615, where D ≥ 1. Each partition unit 615 is coupled to one or more dynamic random access memories (DRAMs) 520 residing within PP memory 604. In one embodiment, the number of partition units 615 equals the number of DRAMs 620, and each partition unit 615 is coupled to a different DRAM 620. In other embodiments, the number of partition units 615 may be different than the number of DRAMs 620. Persons of ordinary skill in the art will appreciate that a DRAM 620 may be replaced with any other technically suitable storage device. In operation, various render targets, such as texture maps and frame buffers, may be stored across DRAMs 620, allowing partition units 615 to write portions of each render target in parallel to efficiently use the available bandwidth of PP memory 604.

A given GPC 608 may process data to be written to any of the DRAMs 620 within PP memory 604. Crossbar unit 610 is configured to route the output of each GPC 608 to the input of any partition unit 615 or to any other GPC 608 for further processing. GPCs 608 communicate with memory interface 614 via crossbar unit 610 to read from or write to various DRAMs 620. In one example embodiment, crossbar unit 610 has a connection to I/O unit 605, in addition to a connection to PP memory 604 via memory interface 614, thereby enabling the processing cores within the different GPCs 608 to communicate with memory 504 or other memory not local to PPU 602. In the example embodiment of FIG. 6, crossbar unit 610 is directly connected with I/O unit 605. In various embodiments, crossbar unit 610 may use virtual channels to separate traffic streams between the GPCs 608 and partition units 615.

GPCs 608 can be programmed to execute processing tasks relating to a wide variety of applications, including, without limitation, linear and nonlinear data transforms, filtering of video and/or audio data, modeling operations (e.g., applying laws of physics to determine position, velocity, and other attributes of objects), image rendering operations (e.g., tessellation shader, vertex shader, geometry shader, and/or pixel/fragment shader programs), general compute operations, etc. In operation, PPU 602 is configured to transfer data from memory 504 and/or PP memory 604 to one or more on-chip memory units, process the data, and write result data back to memory 504 and/or PP memory 604. The result data may then be accessed by other system components, including CPU 506, another PPU 602 within GPU 508, or another GPU 508 within computing device 500. Data transfers between two or more PPUs 602 over high-speed links are referred to herein as peer transfers and such PPUs 602 are referred to herein as peers.

As noted above, any number of PPUs 602 may be included in a GPU 508. For example, multiple PPUs 602 may be provided on a single add-in card, or multiple add-in cards may be connected to interconnect system 502, or one or more of PPUs 602 may be integrated into a bridge chip. PPUs 602 in a multi-PPU system may be identical to or different from one another. For example, different PPUs 602 might have different numbers of processing cores and/or different amounts of PP memory 604. In implementations where multiple PPUs 602 are present, those PPUs may be operated in parallel to process data at a higher throughput than is possible with a single PPU 602. Systems incorporating one or more PPUs 602 may be implemented in a variety of configurations and form factors, including, without limitation, desktops, laptops, handheld personal computers or other handheld devices, servers, workstations, game consoles, embedded systems, and the like.

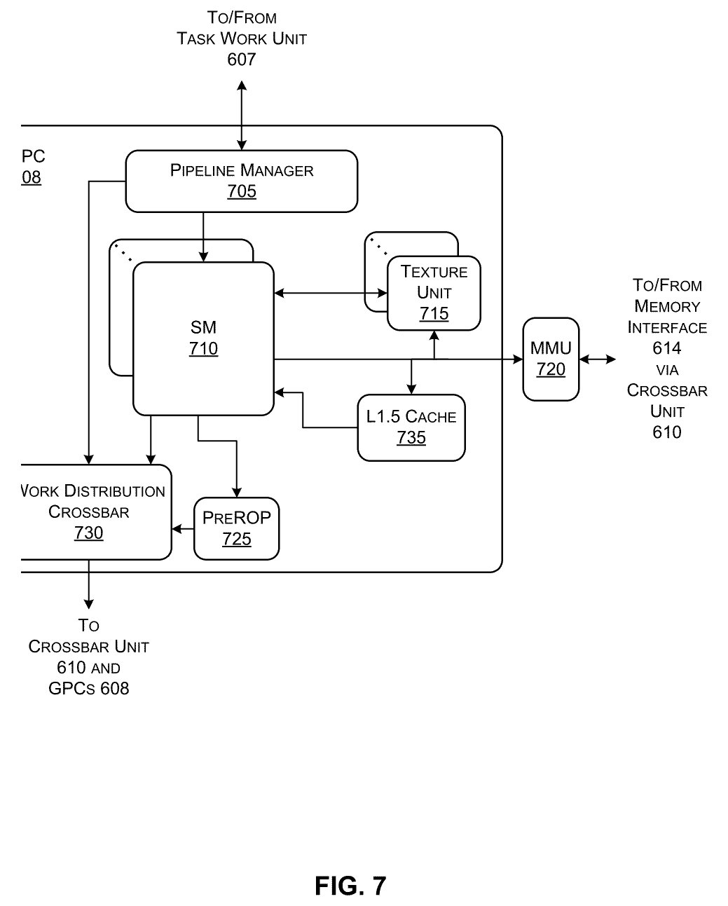

FIG. 7 illustrates an example block diagram of a general processing cluster (GPC) 608, according to certain example embodiments. As illustrated in FIG. 7, the GPC 608 is included in the parallel processing unit (PPU) 602 of FIG. 6, according to various example embodiments. In operation, GPC 608 may be configured to execute a large number of threads in parallel to perform graphics, general processing and/or compute operations. As used herein, a “thread” refers to an instance of a particular program executing on a particular set of input data. In some embodiments, single-instruction, multiple-data (SIMD) instruction issue techniques are used to support parallel execution of a large number of threads without providing multiple independent instruction units. In other example embodiments, single-instruction, multiple-thread (SIMT) techniques are used to support parallel execution of a large number of generally synchronized threads, using a common instruction unit configured to issue instructions to a set of processing engines within GPC 608. Unlike a SIMD execution regime, where all processing engines typically execute identical instructions, SIMT execution allows different threads to more readily follow divergent execution paths through a given program. Persons of ordinary skill in the art will understand that a SIMD processing regime represents a functional subset of a SIMT processing regime.

Operation of GPC 608 may be controlled via a pipeline manager 705 that distributes processing tasks received from a work distribution unit (not shown) within task/work unit 607 to one or more streaming multiprocessors (SMs) 710. Pipeline manager 605 may also be configured to control a work distribution crossbar 730 by specifying destinations for processed data output by SMs 710.

In one example embodiment, GPC 608 includes a set of M of SMs 710, where M ≥ 1. Also, each SM 710 includes a set of functional execution units (not shown), such as execution units and load-store units. Processing operations specific to any of the functional execution units may be pipelined, which enables a new instruction to be issued for execution before a previous instruction has completed execution. Any combination of functional execution units within a given SM 710 may be provided. In various embodiments, the functional execution units may be configured to support a variety of different operations including integer and floating point arithmetic (e.g., addition and multiplication), comparison operations, Boolean operations (e.g., AND, OR, XOR), bit-shifting, and computation of various algebraic functions (e.g., planar interpolation and trigonometric, exponential, and logarithmic functions, etc.). Advantageously, the same functional execution unit can be configured to perform different operations.

In operation, each SM 710 is configured to process one or more thread groups. As used herein, a “thread group” or “warp” refers to a group of threads concurrently executing the same program on different input data, with one thread of the group being assigned to a different execution unit within an SM 710. A thread group may include fewer threads than the number of execution units within the SM 710, in which case some of the execution may be idle during cycles when that thread group is being processed. A thread group may also include more threads than the number of execution units within the SM 710, in which case processing may occur over consecutive clock cycles. Since each SM 710 can support up to G thread groups concurrently, it follows that up to G*M thread groups can be executing in GPC 608 at any given time.

Additionally, a plurality of related thread groups may be active (in different phases of execution) at the same time within an SM 710. This collection of thread groups is referred to herein as a “cooperative thread array” (“CTA”) or “thread array.” The size of a particular CTA is equal to m*k, where k is the number of concurrently executing threads in a thread group, which is typically an integer multiple of the number of execution units within the SM 710, and m is the number of thread groups simultaneously active within the SM 710. In various embodiments, a software application written in the CUDA® programming language describes the behavior and operation of threads executing on GPC 608, including any of the above-described behaviors and operations. A given processing task may be specified in a CUDA® program such that the SM 710 may be configured to perform and/or manage general-purpose compute operations.

Although not shown in FIG. 7, each SM 710 contains a level one (L1) cache or uses space in a corresponding L1 cache outside of the SM 710 to support, among other things, load and store operations performed by the execution units. Each SM 710 also has access to level two (L2) caches (not shown) that are shared among all GPCs 608 in PPU 602. The L2 caches may be used to transfer data between threads. Finally, SMs 710 also have access to off-chip “global” memory, which may include PP memory 604 and/or memory 504. It is to be understood that any memory external to PPU 602 may be used as global memory. Additionally, as shown in FIG. 7, a level one-point-five (L1.5) cache 735 may be included within GPC 608 and configured to receive and hold data requested from memory via memory interface 614 by SM 710. Such data may include, without limitation, instructions, uniform data, and constant data. In embodiments having multiple SMs 710 within GPC 608, the SMs 710 may beneficially share common instructions and data cached in L1.5 cache 735.

Each GPC 608 may have an associated memory management unit (MMU) 720 that is configured to map virtual addresses into physical addresses. In various embodiments, MMU 720 may reside either within GPC 608 or within the memory interface 614. The MMU 720 includes a set of page table entries (PTEs) used to map a virtual address to a physical address of a tile or memory page and optionally a cache line index. The MMU 720 may include address translation lookaside buffers (TLB) or caches that may reside within SMs 710, within one or more L1 caches, or within GPC 608.

In graphics and compute applications, GPC 608 may be configured such that each SM 710 is coupled to a texture unit 715 for performing texture mapping operations, such as determining texture sample positions, reading texture data, and filtering texture data.

In operation, each SM 710 transmits a processed task to work distribution crossbar 730 in order to provide the processed task to another GPC 608 for further processing or to store the processed task in an L2 cache (not shown), PP memory 604, or memory 504 via crossbar unit 610. In addition, a pre-raster operations (preROP) unit 725 is configured to receive data from SM 710, direct data to one or more raster operations (ROP) units within partition units 615, perform optimizations for color blending, organize pixel color data, and perform address translations.

It will be appreciated that the core architecture described herein is illustrative and that variations and modifications are possible. Among other things, any number of processing units, such as SMs 710, texture units 715, or preROP units 725, may be included within GPC 608. Further, as described above in conjunction with FIG. 6, PPU 602 may include any number of GPCs 608 that are configured to be functionally similar to one another so that execution behavior does not depend on which GPC 608 receives a particular processing task. Further, each GPC 608 operates independently of the other GPCs 608 in PPU 602 to execute tasks for one or more application programs. In view of the foregoing, persons of ordinary skill in the art will appreciate that the architecture described in FIGS. 1-6 in no way limits the scope of the various example embodiments of the present disclosure.

As used herein, references to shared memory may include any one or more technically feasible memories, including, without limitation, a local memory shared by one or more SMs 710, or a memory accessible via the memory interface 614, such as a cache memory, PP memory 604, or memory 504. Please also note, as used herein, references to cache memory may include any one or more technically feasible memories, including, without limitation, an L1 cache, an L1.5 cache, and the L2 caches.

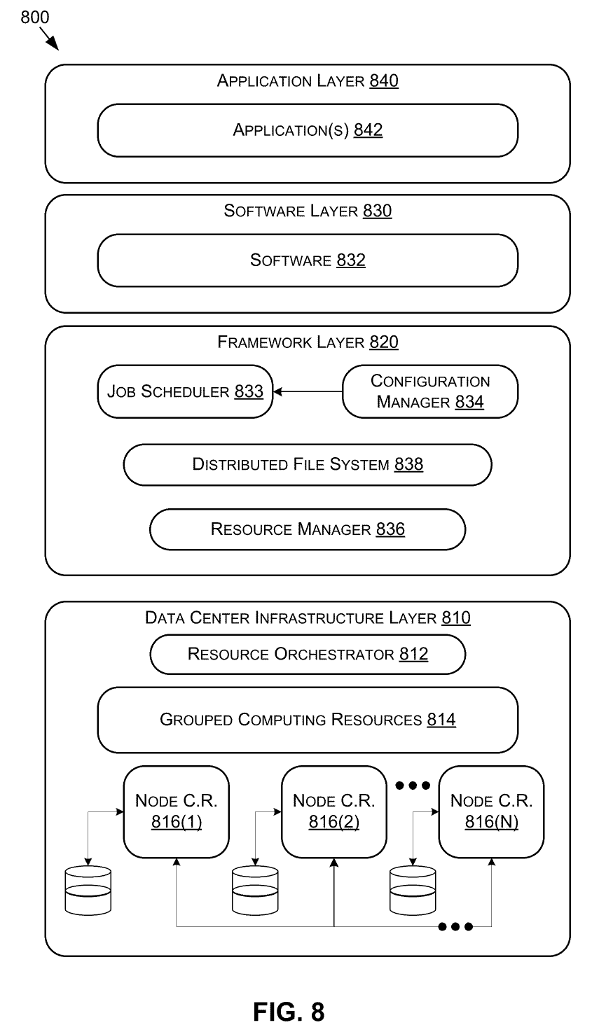

FIG. 8 illustrates an example data center 800, according to certain example embodiments. The data center 800 may be used in at least one embodiment of the present disclosure. As illustrated in FIG. 8, the data center 800 may include a data center infrastructure layer 810, a framework layer 820, a software layer 830, and/or an application layer 840.

As illustrated in FIG. 8, the data center infrastructure layer 810 may include a resource orchestrator 812, grouped computing resources 814, and node computing resources (“node C.R.s”) 816(1)-816(N), where “N” represents any whole, positive integer. In at least one example embodiment, node C.R.s 816(1)-816(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some example embodiments, one or more node C.R.s from among node C.R.s 816(1)-816(N) may correspond to a server having one or more of the above-mentioned computing resources. In other example embodiments, the node C.R.s 816(1)-816(N) may include one or more virtual components, such as vGPUs, vCPUs, and/or the like, and/or one or more of the node C.R.s 816(1)-816(N) may correspond to a virtual machine (VM).

In certain example embodiments, grouped computing resources 814 may include separate groupings of node C.R.s 816 housed within one or more racks (not shown), or many racks housed in data centers at various geographical locations (also not shown). Separate groupings of node C.R.s 816 within grouped computing resources 814 may include grouped compute, network, memory, or storage resources that may be configured or allocated to support one or more workloads. In at least one embodiment, several node C.R.s 816 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 812 may configure or otherwise control one or more node C.R.s 816(1)-816(N) and/or grouped computing resources 814. In certain example embodiments, resource orchestrator 812 may include a software design infrastructure (SDI) management entity for the data center 800. The resource orchestrator 812 may include hardware, software, or some combination thereof.

In certain example embodiments, as shown in FIG. 8, framework layer 820 may include a job scheduler 833, a configuration manager 834, a resource manager 836, and/or a distributed file system 838. The framework layer 820 may include a framework to support software 832 of software layer 830 and/or one or more application(s) 842 of application layer 840. The software 832 or application(s) 842 may respectively include web-based service software or applications, such as those provided by Amazon Web Services, Google Cloud and Microsoft Azure. The framework layer 820 may be, but is not limited to, a type of free and open-source software web application framework such as Apache SparkTM (hereinafter “Spark”) that may utilize distributed file system 838 for large-scale data processing (e.g., "big data"). In certain example embodiments, job scheduler 833 may include a spark driver to facilitate scheduling of workloads supported by various layers of data center 800. The configuration manager 834 may be capable of configuring different layers such as software layer 830 and framework layer 820 including Spark and distributed file system 838 for supporting large-scale data processing. The resource manager 836 may be capable of managing clustered or grouped computing resources mapped to or allocated for support of distributed file system 838 and job scheduler 833. In certain example embodiments, clustered or grouped computing resources may include grouped computing resource 814 at data center infrastructure layer 810. The resource manager 836 may coordinate with resource orchestrator 812 to manage these mapped or allocated computing resources.

In certain example embodiments, software 832 included in software layer 830 may include software used by at least portions of node C.R.s 816(1)-816(N), grouped computing resources 814, and/or distributed file system 838 of framework layer 820. One or more types of software may include, but are not limited to, Internet web page search software, e-mail virus scan software, database software, and streaming video content software.

In certain example embodiments, application(s) 842 included in application layer 840 may include one or more types of applications used by at least portions of node C.R.s 816(1)-816(N), grouped computing resources 814, and/or distributed file system 838 of framework layer 820. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

According to certain example embodiments, any of configuration manager 834, resource manager 836, and resource orchestrator 812 may implement any number and type of self-modifying actions based on any amount and type of data acquired in any technically feasible fashion. Self-modifying actions may relieve a data center operator of data center 800 from making possibly bad configuration decisions and possibly avoiding underutilized and/or poor performing portions of a data center.

The data center 800 may include tools, services, software, or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 800. In at least one embodiment, trained or deployed machine learning models corresponding to one or more neural networks may be used to infer or predict information using resources described above with respect to the data center 800 by using weight parameters calculated through one or more training techniques, such as but not limited to those described herein.

In certain example embodiments, the data center 800 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

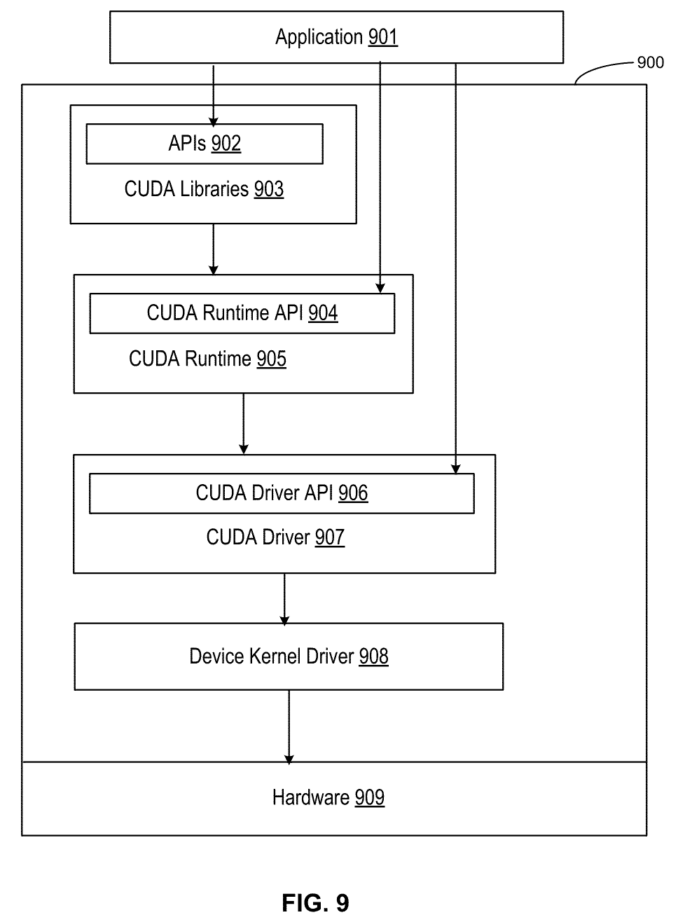

FIG. 9 illustrates an example CUDA® implementation, according to certain example. In certain example embodiments, a CUDA® software stack 900, on which an application 901 may be launched, includes CUDA® libraries 903, a CUDA® runtime 905, a CUDA® driver 907, and a device kernel driver 908. In certain example embodiments, CUDA® software stack 900 executes on hardware 909, which may include a GPU that supports CUDA®.

In at least one embodiment, application 901, CUDA® driver 907 includes a library (libcuda.so) that implements a CUDA® driver API 906. Similar to a CUDA® runtime API 904 implemented by a CUDA® runtime library (cudart), CUDA® driver API 906 may, without limitation, expose functions for memory management, execution control, device management, error handling, synchronization, and/or graphics interoperability, among other things, in at least one embodiment. In at least one embodiment, CUDA® driver API 906 differs from CUDA® runtime API 904 in that CUDA® runtime API 904 simplifies device code management by providing implicit initialization, context (analogous to a process) management, and module (analogous to dynamically loaded libraries) management. In contrast to high-level CUDA® runtime API 904, CUDA® driver API 906 is a low-level API providing more fine-grained control of the device, particularly with respect to contexts and module loading, in at least one embodiment. In at least one embodiment, CUDA® driver API 906 may expose functions for context management that are not exposed by CUDA® runtime API 904. In certain example embodiments, CUDA® driver API 906 may also be language-independent and may support, for example, OpenCL in addition to CUDA® runtime API 904. In other example embodiments, development libraries, including CUDA® runtime 905, may be considered as separate from driver components, including user-mode CUDA® driver 907 and device kernel driver 908 (also sometimes referred to as a “display” driver).

In certain example embodiments, CUDA® libraries 903 may include, but are not limited to, mathematical libraries, deep learning libraries, parallel algorithm libraries, and/or signal/image/video processing libraries, which parallel computing applications such as application 901 may utilize. In other example embodiments, CUDA® libraries 903 may implement APIs 902, and may include mathematical libraries such as a cuBLAS library that is an implementation of Basic Linear Algebra Subprograms (“BLAS”) for performing linear algebra operations, a cuFFT library for computing fast Fourier transforms (“FFTs”), and a cuRAND library for generating random numbers, among others. In at least one embodiment, CUDA® libraries 903 may include deep learning libraries such as a cuDNN library of primitives for deep neural networks and a TensorRT platform for high-performance deep learning inference, among others.

According to certain example embodiments, processors and memories described herein may be included in or may form a part of processing circuitry or control circuitry. In addition. For instance, in certain example embodiments, the GPU 508 may be controlled by a memory 504 and a processor 506 to receive an instruction for performing a collective operation across a plurality of processing elements. According to certain example embodiments, the instruction specifies a first virtual address that is included in a first set of contiguous virtual addresses for unicast operations. The GPU 508 may also be controlled by memory 504 and processor 506 to determine an offset of the first virtual address from a first base address associated with the first set of contiguous virtual addresses. The GPU 508 may further be controlled by memory 504 and processor 506 to translate the first virtual address to a corresponding multicast virtual address based on the offset. According to certain example embodiments, the multicast virtual address may be included in a second set of contiguous virtual addresses for multicast operations. According to other example embodiments, the multicast virtual address may be located at the offset from a second base address associated with the second set of contiguous virtual addresses. The GPU 508 may further be controlled by memory 504 and processor 506 to cause the collective operation to be performed based at least on the multicast virtual address.

In some example embodiments, the GPU 508 may include means for performing a method, a process, or any of the variants discussed herein. Examples of the means may include one or more processors, memory, controllers, and/or computer program code for causing the performance of the operations.

CLAUSE 1: A method, comprising receiving an instruction for performing a collective operation across at least one processing element, wherein the instruction specifies a first virtual address that is included in a first set of contiguous virtual addresses for unicast operations, determining an offset of the first virtual address from a first base address associated with the first set of contiguous virtual addresses, translating the first virtual address to a corresponding multicast virtual address based on the offset, wherein the multicast virtual address is included in a second set of contiguous virtual addresses for multicast operations, and wherein the multicast virtual address is located at the offset from a second base address associated with the second set of contiguous virtual addresses, and causing the collective operation to be performed based at least on the multicast virtual address.

CLAUSE 2: The method of clause 1, wherein the at least one processing element is associated with the first set of contiguous virtual addresses and the second set of contiguous virtual addresses, and wherein the first set of contiguous virtual addresses corresponding to the at least one processing element is symmetric and the second set of contiguous virtual addresses corresponding to the at least one processing element is symmetric.

CLAUSE 3: The method of clause 1 or 2, further comprising, for a given processing element of the at least one processing unit, binding a virtual address in the first set of contiguous virtual addresses to a first physical address in a physical memory space associated with the given processing element, wherein a virtual address in the second set of contiguous virtual addresses that is located at a same offset as the virtual address in the first set of contiguous virtual addresses is bound the first physical address.

CLAUSE 4: The method of any of clauses 1-3, wherein the virtual address in the first set of contiguous virtual addresses is located at a current offset from the first base virtual address and the virtual address in the second set of contiguous virtual addresses is located at the current offset from the second base virtual address.

CLAUSE 5: The method of any of clauses 1-4, wherein the collective operation is performed, at least in part, within a switch coupled to the at least one processing element.

CLAUSE 6: The method of any of clauses 1-5, further comprising determining that the first virtual address is to be translated to the multicast virtual address based on a type of operation associated with the collective operation.

CLAUSE 7: The method of any of clauses 1-6, wherein the instruction is received for a central processing unit coupled to the at least one processing element, and wherein the translating the first virtual address to the corresponding multicast virtual address occurs within the at least one processing element.

CLAUSE 8: The method of any of clauses 1-7, wherein the translating the first virtual address to the corresponding multicast virtual address is an O(1) operation.

CLAUSE 9: The method of any of clauses 1-8, wherein the collective operation is performed across the at least one processing element based on data stored in the multicast virtual address corresponding to the at least one processing element.

CLAUSE 10: The method of any of clauses 1-9, wherein at least a partial result of the collective operation is stored in the multicast virtual address corresponding to the at least one processing element.

CLAUSE 11: A system, comprising: at least one processor; and at least one memory storing instructions, wherein the instructions, when executed by the at least one processor, cause the apparatus at least to: receive an instruction for performing a collective operation across at least one processing element, wherein the instruction is associated with a unicast virtual address that is included in a first set of contiguous virtual addresses, translate the unicast virtual address to a corresponding multicast virtual address based on an offset of the unicast virtual address from a first base address of the first set of contiguous virtual addresses, wherein the multicast virtual address is located at the offset from a second base address associated with the second set of contiguous virtual addresses, and cause the collective operation to be performed based at least on the multicast virtual address.

CLAUSE 12: The system according to clause 11, wherein the at least one processing element is associated with the corresponding first set of contiguous virtual addresses and the second set of contiguous virtual addresses, and wherein the first set of contiguous virtual addresses corresponding to the at least one processing element is symmetric and the second set of contiguous virtual addresses corresponding to the at least one processing element is symmetric.

CLAUSE 13: The system of clause 11 or 12, wherein the at least one memory stores instructions that when executed by the at least one processor, further cause the apparatus at least to: for a given processing element of the at least one processing element, bind a virtual address in the first set of contiguous virtual addresses to a first physical address in a physical memory space associated with the given processing element, wherein a virtual address in the second set of contiguous virtual addresses that is located at a same offset as the virtual address in the first set of contiguous virtual addresses is bound the first physical address.

CLAUSE 14: The system of any of clauses 11-13, wherein the virtual address in the first set of contiguous virtual addresses is located at a current offset from the first base virtual address and the virtual address in the second set of contiguous virtual addresses is located at the current offset from the second base virtual address.

CLAUSE 15: The system of any of clauses 11-14, wherein the at least one memory stores instructions that when executed by the at least one processor, further cause the apparatus at least to: determine that the unicast virtual address is to be translated to the multicast virtual address based on a type of operation associated with the collective operation.

CLAUSE 16: The system of any of clauses 11-15, wherein the instruction is received for a central processing unit coupled to the at least one processing element, and wherein the translating the unicast virtual address to the corresponding multicast virtual address occurs within the at least one processing element.

CLAUSE 17: The system of any of clauses 11-16, wherein the translating the unicast virtual address to the corresponding multicast virtual address is an O(1) operation.

CLAUSE 18: The system of any of clauses 11-17, wherein the collective operation is performed across the at least one processing element based on data stored in the multicast virtual address corresponding to the at least one processing element.

CLAUSE 19: The system of any of clauses 11-18, wherein at least a partial result of the collective operation is stored in the multicast virtual address corresponding to the at least one processing element.

CLAUSE 20. At least one processor, comprising: processing circuitry to cause a collective operation to be performed across at least one processing unit based at least on a virtual address of a first type determined from at least an offset of a corresponding virtual address of a second type in a set of contiguous virtual addresses for operations associated with the second type.

Any and all combinations of any of the claim elements recited in any of the claims and/or any elements or clauses described in this application, in any fashion, fall within the contemplated scope of the present disclosure and protection.

Certain example embodiments may be directed to an apparatus that includes means for performing any of the methods described herein including, for example, means for receiving an instruction for performing a collective operation across a plurality of processing elements. According to certain example embodiments, the instruction specifies a first virtual address that is included in a first set of contiguous virtual addresses for unicast operations. The apparatus may also include means for determining an offset of the first virtual address from a first base address associated with the first set of contiguous virtual addresses. The apparatus may further include means for translating the first virtual address to a corresponding multicast virtual address based on the offset. According to certain example embodiments, the multicast virtual address may be included in a second set of contiguous virtual addresses for multicast operations. According to other example embodiments, the multicast virtual address may be located at the offset from a second base address associated with the second set of contiguous virtual addresses. In certain example embodiments, the apparatus may further include means for causing the collective operation to be performed based at least on the multicast virtual address.

Certain example embodiments described herein provide several technical improvements, enhancements, and /or advantages. For instance, in some example embodiments, it may be possible to create on-demand zero-copy multicast communication buffers at the same virtual offset as the corresponding unicast communication buffers managed by a symmetric heap allocator using a CUDA® virtual memory management subsystem to create 2:1 virtual to physical memory mappings. In other example embodiments, it may be possible to provide a O(1) unicast to multicast address translation methodology as the unicast and multicast communication buffers may be allocated in a contiguous virtual address space of the symmetric heap(s) across all participating GPUs in the multicast group. As such, it may be possible to allow for simple address arithmetic based on the specific translation scheme to be deployed. In further example embodiments, it may be possible to accelerate latency of datapath communication by a factor of 2x (with zero-copy), and by a factor of N or log N (with O(1) symmetric mapping), where N is the number of communication buffers created in an application.

One having ordinary skill in the art will readily understand that the invention as discussed above may be practiced with procedures in a different order which are different than those which are disclosed. Therefore, although the invention has been described based upon these example embodiments, it would be apparent to those of skill in the art that certain modifications, variations, and alternative constructions would be apparent, while remaining within the spirit and scope of example embodiments.

We claim:

1. A method, comprising:
receiving an instruction for performing a collective operation across at least one processing element, wherein the instruction specifies a first virtual address that is included in a first set of contiguous virtual addresses for unicast operations;
determining an offset of the first virtual address from a first base address associated with the first set of contiguous virtual addresses;
translating the first virtual address to a corresponding multicast virtual address based on the offset, wherein the multicast virtual address is included in a second set of contiguous virtual addresses for multicast operations, and wherein the multicast virtual address is located at the offset from a second base address associated with the second set of contiguous virtual addresses; and
causing the collective operation to be performed based at least on the multicast virtual address.

2. The method of claim 1,
wherein the at least one processing element is associated with the first set of contiguous virtual addresses and the second set of contiguous virtual addresses, and
wherein the first set of contiguous virtual addresses corresponding to the at least one processing element is symmetric and the second set of contiguous virtual addresses corresponding to the at least one processing element is symmetric.

3. The method of claim 2, further comprising, for a given processing element of the at least one processing unit,
binding a virtual address in the first set of contiguous virtual addresses to a first physical address in a physical memory space associated with the given processing element,
wherein a virtual address in the second set of contiguous virtual addresses that is located at a same offset as the virtual address in the first set of contiguous virtual addresses is bound the first physical address.

4. The method of claim 3, wherein the virtual address in the first set of contiguous virtual addresses is located at a current offset from the first base virtual address and the virtual address in the second set of contiguous virtual addresses is located at the current offset from the second base virtual address.

5. The method of claim 1, wherein the collective operation is performed, at least in part, within a switch coupled to the at least one processing element.

6. The method of claim 1, further comprising determining that the first virtual address is to be translated to the multicast virtual address based on a type of operation associated with the collective operation.

7. The method of claim 1,
wherein the instruction is received for a central processing unit coupled to the at least one processing element, and
wherein the translating the first virtual address to the corresponding multicast virtual address occurs within the at least one processing element.

8. The method of claim 1, wherein the translating the first virtual address to the corresponding multicast virtual address is an O(1) operation.

9. The method of claim 1, wherein the collective operation is performed across the at least one processing element based on data stored in the multicast virtual address corresponding to the at least one processing element.

10. The method of claim 1, wherein at least a partial result of the collective operation is stored in the multicast virtual address corresponding to the at least one processing element.

11. A system, comprising:
at least one processor; and
at least one memory storing instructions, wherein the instructions, when executed by the at least one processor, cause the apparatus at least to:
receive an instruction for performing a collective operation across at least one processing element, wherein the instruction is associated with a unicast virtual address that is included in a first set of contiguous virtual addresses;
translate the unicast virtual address to a corresponding multicast virtual address based on an offset of the unicast virtual address from a first base address of the first set of contiguous virtual addresses, wherein the multicast virtual address is located at the offset from a second base address associated with the second set of contiguous virtual addresses; and
cause the collective operation to be performed based at least on the multicast virtual address.

12. The system according to claim 11
wherein the at least one processing element is associated with the corresponding first set of contiguous virtual addresses and the second set of contiguous virtual addresses, and
wherein the first set of contiguous virtual addresses corresponding to the at least one processing element is symmetric and the second set of contiguous virtual addresses corresponding to the at least one processing element is symmetric.

13. The system of claim 12, wherein the at least one memory stores instructions that when executed by the at least one processor, further cause the apparatus at least to:
for a given processing element of the at least one processing element, bind a virtual address in the first set of contiguous virtual addresses to a first physical address in a physical memory space associated with the given processing element,
wherein a virtual address in the second set of contiguous virtual addresses that is located at a same offset as the virtual address in the first set of contiguous virtual addresses is bound the first physical address.

14. The system of claim 13, wherein the virtual address in the first set of contiguous virtual addresses is located at a current offset from the first base virtual address and the virtual address in the second set of contiguous virtual addresses is located at the current offset from the second base virtual address.

15. The system of claim 11, wherein the at least one memory stores instructions that when executed by the at least one processor, further cause the apparatus at least to:
determine that the unicast virtual address is to be translated to the multicast virtual address based on a type of operation associated with the collective operation.

16. The system of claim 11,
wherein the instruction is received for a central processing unit coupled to the at least one processing element, and
wherein the translating the unicast virtual address to the corresponding multicast virtual address occurs within the at least one processing element.

17. The system of claim 11, wherein the translating the unicast virtual address to the corresponding multicast virtual address is an O(1) operation.

18. The system of claim 11, wherein the collective operation is performed across the at least one processing element based on data stored in the multicast virtual address corresponding to the at least one processing element.

19. The system of claim 11, wherein at least a partial result of the collective operation is stored in the multicast virtual address corresponding to the at least one processing element.

20. At least one processor, comprising:
processing circuitry to cause a collective operation to be performed across at least one processing unit based at least on a virtual address of a first type determined from at least an offset of a corresponding virtual address of a second type in a set of contiguous virtual addresses for operations associated with the second type.
